(19) United States
(12) Patent Application Publication
(10) Pub. No.: US 2017/0003401 A1
(43) Pub. Date: Jan. 5, 2017

(54) FLEXIBLE X-RAY DETECTOR APPARATUS, SYSTEM, AND METHOD OF USING THE SAME

(71) Applicant: General Electric Company, Schenectady, NY (US)

(72) Inventors: Nicholas Konkle, Waukesha, WI (US); John Sabol, Sussex, WI (US); Katelyn Nye, Milwaukee, WI (US); Andrea Schmitz, Niskayuna, NY (US); Aaron Couture, Niskayuna, NJ (US); Kevin Kinsey, Waukesha, WI (US)

(21) Appl. No.: 14/790,915

(22) Filed: Jul. 2, 2015

(51) Int. Cl. G01T 1/20; H05G 1/02; G01T 1/203

(52) U.S. Cl. CPC G01T 1/2018; G01T 1/203; H05G 1/02

(57) ABSTRACT

A flexible x-ray detector and a method and system of using the same to acquire one or more x-ray images are disclosed. The flexible x-ray detector apparatus includes a curvature-fixing holder, which has a predetermined curvature. The curvature-fixing holder has a first end and a second end, which has a perimeter defining an internal slot or recess. The flexible detector is configured to be inserted into the recess of the curvature-fixing holder and follows the predetermined curvature of the recess. The flexible x-ray detector may further include a scintillator and a flexible substrate. A method of using a flexible x-ray detector apparatus as well as a system including one or more flexible x-ray detector apparatus are also disclosed.

### BACKGROUND

The subject matter disclosed herein relates generally to systems and methods for imaging, for example, X-ray imaging.

X-ray examination has long been known in medical, structural, and investigative applications, where an image is desired of an object or patient, either below an exterior surface, or where it is undesirable to damage or dissect an object or patient. In medical applications, x-rays are taken of a patient to diagnose a variety of conditions, to track progress or regress of a medical condition, and to provide a baseline image to a user, such as a doctor. In other applications, x-ray imaging may be used to inspect the interiors of buildings or the operations of a machine, or may be used in historical investigations, where a user must operate under delicate circumstances to preserve an artifact.

Many conventional detectors have been limited to flat planes, and may be relatively heavy, thick, and inflexible. With these conventional x-ray systems, the detectors may result in distorted images for various reasons, one of which is that the same flat plane detectors are used on objects or volumes having different geometric shapes and structures. For example, a flat silicon based detector may result in distorted images, when such a detector is used on a structure having a non-flat surface. Where poor detector contact is made to the surface of an object being examined, the geometric unsharpness will increase causing blur, distorting magnification, and image distraction. These image issues arise when the distance between portions of the x-ray detector and curved surfaces change, because the detector is not shaped to conform or fit to a curved surface of an object.

In order to prevent the imaging problems addressed above, flexible detectors, such as organic photodiode detectors, have been developed. These flexible detectors may be utilized in situations where conventional or fixed detectors would be inappropriate or inadequate.

The use of a flexible x-ray detector, however, may create additional image processing concerns, because of the imprecise nature of the curved detector's geometric configuration during imaging. The geometric configuration of the flexible x-ray detector may lead to unwanted and undesirable image distortion due to the curved and/or flexible nature of the detector. The image distortion could make image processing increasingly difficult or lead to a missed target of interest or misdiagnosis. While a flexible detector may be used alone to enable a user to utilize a custom-fit curvature, the user will not be able to remove inherent image distortion without knowing the detector curvature.

### SUMMARY

The subject matter disclosed herein provides an apparatus with a flexible detector of known curvature. The various embodiments disclosed provide an x-ray detector apparatus or system that includes a curvature-fixing holder, which imparts or incorporates a known curvature, which may be the curvature of the holder, to a flexible x-ray detector.

In one embodiment, an x-ray detector apparatus is provided including a curvature-fixing holder and a flexible x-ray detector, the curvature-fixing holder having a predetermined curvature, a first end, a second end, and defining a recess that has substantially the same predetermined curvature as the holder, the flexible x-ray detector having a scintillator and a flexible substrate, with the flexible x-ray detector configured to be inserted into the recess and follow the predetermined curvature of the recess.

In one embodiment, an x-ray detector system is provided including a plurality of curvature-fixing holders and a flexible x-ray detector, the plurality of curvature-fixing holders each having a different predetermined curvature, a first end, a second end, and defining a recess that has substantially the same predetermined curvature as the respective holder, the flexible x-ray detector having a scintillator and a flexible substrate, with the flexible x-ray detector configured to be inserted into the recess and follow the predetermined curvature of the recess of each holder of the plurality of curvature-fixing holders.

In one embodiment, a method of using an x-ray detector apparatus is disclosed, the method including providing an apparatus that includes a curvature-fixing holder and a flexible x-ray detector, the curvature-fixing holder having a predetermined curvature, a first end, a second end, and defining a recess that has substantially the same predetermined curvature as the holder, the flexible x-ray detector having a scintillator and a flexible substrate, with the flexible x-ray detector configured to be inserted into the recess and follow the predetermined curvature of the recess, where the method includes inserting the flexible x-ray detector into the holder and using the x-ray detector.

In one embodiment, a method of using an x-ray detector apparatus is disclosed, the method including providing a system that includes a plurality of curvature-fixing holders and a flexible x-ray detector, the plurality of curvature-fixing holders each having a different predetermined curvature, a first end, a second end, and defining a recess that has substantially the same predetermined curvature as the respective holder, the flexible x-ray detector having a scintillator and a flexible substrate, with the flexible x-ray detector configured to be inserted into the recess and follow the predetermined curvature of the recess of each holder, where the method includes inserting the flexible x-ray detector into the a first holder of the plurality of curvature-fixing holders, using the flexible x-ray detector, removing the flexible x-ray detector from the first holder, inserting the flexible x-ray detector into a second holder of the plurality of curvature-fixing holders, and using the flexible x-ray detector in the second holder.

In one embodiment, an x-ray detector system includes an adjustable curvature-fixing holder where the holder has a first end and a second end and the holder defines a recess. The x-ray detector system further includes a plurality of flexible x-ray detectors, where each detector has a different size relative to one another and each flexible x-ray detector includes a scintillator and a flexible substrate. The adjustable curvature-fixing holder of the system is configured to be adjusted to accommodate the size of each of the plurality of flexible x-ray detectors.

### BRIEF DESCRIPTION OF THE DRAWINGS

The operation of the inventive methods, systems, and apparatus will become apparent from the following description taken in conjunction with the drawings, in which:

FIG. 1 is a schematic diagram illustrating an x-ray detector apparatus where a detector has been inserted into a holder;

FIG. 2 is a schematic diagram illustrating a flexible x-ray detector 104 being inserted into the curvature-fixing holder 102;

FIG. 3 is a schematic diagram illustrating an x-ray detector apparatus in use with an x-ray source;

FIG. 4 is a schematic diagram illustrating an x-ray detector apparatus comprising a handle;

FIG. 5 is a schematic diagram illustrating a convex curvature-fixing holder in accordance with an embodiment;

FIG. 6 is a schematic diagram illustrating a convex curvature-fixing holder in accordance with an embodiment;

FIG. 7 is a schematic diagram illustrating a convex curvature-fixing holder in accordance with an embodiment;

FIG. 8 is a schematic diagram illustrating a concave curvature-fixing holder in accordance with an embodiment;

FIG. 9 is a schematic diagram illustrating a concave curvature-fixing holder in accordance with an embodiment;

FIG. 10 is a schematic diagram illustrating a concave curvature-fixing holder in accordance with an embodiment;

FIG. 11 is a schematic diagram illustrating complimenting features of components of an x-ray detector apparatus;

FIG. 12 is a schematic diagram illustrating complimenting features of components of an x-ray detector apparatus;

FIG. 13 is a schematic diagram illustrating complimenting features of components of an x-ray detector apparatus; and

FIG. 14 is a flowchart of a method of using an x-ray detector apparatus in accordance with various embodiments.

### DETAILED DESCRIPTION

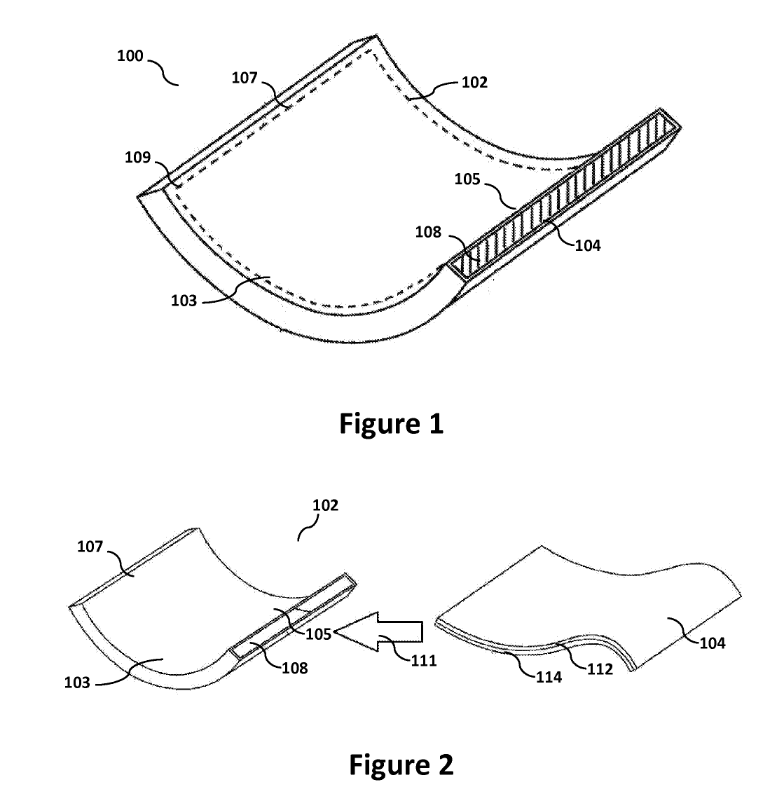

Referring to FIG. 1, an x-ray detector apparatus is shown according to an embodiment of the invention. The detector apparatus may be based on film/screen, computed radiography (CR), digital radiography (DR) technologies, or other x-ray detectors known in the field. In an exemplary embodiment, a curved x-ray detector apparatus 100 includes a curvature-fixing holder 102 and a flexible x-ray detector 104, which has been inserted into or is held by curvature-fixing holder 102. FIG. 1 shows flexible x-ray detector 104 after it has been inserted into curvature-fixing holder 102. The curvature-fixing holder 102 comprises a holder body 103 having a perimeter defining an internal slot or recess 108, and having a first end 105 and a second end 107. In some embodiments, the holder body 103 may have more than a first end and a second end. In embodiments, a handle may be attached to curvature fixing holder 102 to facilitate the moving and placing of curvature fixing holder 102 throughout a procedure and/or during storage, or at other times.

Advantageously, the curvature-fixing holder 102 has a predetermined or known curvature, which aids in image processing. The curvature-fixing holder 102 is typically firmer than the flexible x-ray detector 104, which helps the detector to retain a shape. The curvature-fixing holder 102 may be at least partially formed of carbon fiber or a similar material which permits x-ray penetration through the curvature-fixing holder 102 to an x-ray detector 104. In some embodiments where flexibility would be useful, the curvature-fixing holder 102 is comprised of low temperature thermoplastics, which may be reset to a different curvature as desired. In another embodiment, the curvature-fixing holder 102 has a fixed curvature that cannot be modified and/or flexed.

In an embodiment, the curvature-fixing holder includes readout electronics or data acquisition systems. The readout electronics capture information and communicate information, for instance, the energy level of a detector indicating the energy spectrum of the radiation and/or the timing information used to provide position sensitivity for image reconstruction.

Holder body 103 of curvature-fixing holder 102 defines the internal slot or recess 108, which extends into the holder body toward any or all portions of the perimeter. Advantageously, the recess 108 has a curvature, which is substantially or approximately the same as the curvature of the curvature-fixing holder 102. In an embodiment, the recess 108 extends substantially from the first end 105 of the holder body 103 to the second end 107 of holder body 103.

The recess 108 is configured to receive at least a portion of flexible x-ray detector 104. As shown in FIG. 1 by dashed line 109, flexible x-ray detector 104 has been inserted into the recess 108 and is held within the holder body 103. In an embodiment, recess 108 may have a fixed shape, which substantially corresponds to the flexible x-ray detector 104. In other embodiments, recess 108 may have a flexible or manipulatable shape that expands or conforms to a shape of flexible x-ray detector 104 as flexible x-ray detector 104 is inserted into recess 108. In such embodiments where recess 108 may be flexible or manipulatable, curvature-fixing holder 102 may be flexible or may be in a form which cannot be modified or flexed.

Referring to FIG. 2, the flexible x-ray detector 104 is shown being inserted into the curvature-fixing holder 102. As shown by arrow 111, the flexible x-ray detector 104 may be inserted into the curvature-fixing holder 102. More specifically, the flexible x-ray detector 104 may be inserted manually or automatically, by a user or a machine, into the recess 108 of the holder body 103 of curvature-fixing holder 102. The flexible x-ray detector 104 is configured to be slid, placed, or otherwise inserted into recess 108 of the curvature-fixing holder 102, partially, entirely, or at some position in-between.

As the flexible detector 104 is inserted into the holder 102, said detector slides or moves within the recess 108 relative to the holder body 103, following the curvature of the recess 108 and ultimately conforming at least in part to the curvature and/or shape of the recess 108. Once inserted, the detector 104 is held in place relative to the holder 102 either by friction or by a fixing device or structure (not shown), such as a latch, fastener or any other mechanical or electro-mechanical fastener currently known or that later becomes known, to form an x-ray detector apparatus 100, such as the apparatus illustrated in FIG. 1. It should be noted that the configurations—e.g. size, shape, thickness, curvature, arc length and all other dimensions and geometric characteristics—defining the detector apparatus depicted in FIG. 1 and FIG. 2 are for illustration purposes only and are not intended to limit the scope of the claimed invention with respect to these configurations.

After one or more x-rays are taken, a procedure is complete, or a user decides on removal, flexible x-ray detector 104 may be removed from curvature-fixing holder 102 to move from a configuration similar to that shown in FIG. 1 to a configuration similar to that shown in FIG. 2. The flexible x-ray detector is generally removable relative to the curvature-fixing holder 102, but in some embodiments may remain fixed in curvature-fixing holder 102 after insertion.

The flexible x-ray detector 104 may comprise a scintillator 112 and/or a substrate 114. The scintillator 112 may comprise a layer of scintillating phosphor particles dispersed in a flexible binder. Various scintillators may be used in flexible x-ray detector 104, such as doped Gadolinium oxysuphide (e.g.: Gd₂O₂S:Tb, Gd₂O₂S:Eu³⁺) or other rare-earth phosphor particles in a polyvinyl butyral binder formulation.

The scintillator 112 may be formed or positioned over the cathode of photodiodes, discussed below, and may comprise an environmental cover, which can cover the scintillator 112. In operation, the scintillator 112 is excited by incident X-rays and produces visible light in response to this excitation. The scintillator 112 may be a monolithic scintillator or a pixelated scintillator array. Gadolinium oxy-sulfide (GOS (Gd₂O₂S)) is one possible scintillator material, which is in the form of thin film with a thickness ranging from less than a millimeter to one, two, or three millimeters. In some embodiments, the thin film may be more than three millimeters in thickness. In another embodiment, the scintillator material may comprise cesium iodide (CsI), which can be used for a high sensitivity scintillator, and may be deposited by thermal evaporation. In yet another embodiment, the scintillator 112 may be a PIB (particle in binder) scintillator, where scintillating particles may be incorporated in a binder matrix material and flattened on a substrate. The visible light generated by the scintillator irradiates the photodiode layer disposed on a TFT array.

The substrate 114 is typically flexible or substantially flexible. Substrate 114 may comprise polyethylene naphthalate (PEN), a polyamide film, or a combination thereof. Drive and readout electronics may be provided on flex circuitry, positioned on the substrate 114, or a combination thereof. The substrate 114 may be composed of materials such as glass, plastic, such as polyethylene terephthalate, polybutylene phthalate, polyethylene naphthalate, polystyrene, polycarbonate, polymethylmethacrylate, polyether sulfone, polyallylate, polyimide, polycycloolefin, norbornene resins, fluoropolymers, or similar materials, metals and metal foils, such as stainless steel, aluminum, silver and gold, metal oxides, such as titanium oxide and zinc oxide, semiconductors, such as silicon or organic based semiconductors, or any combination of these materials. Substrate 114 may also be formed of composite materials, such as fiber reinforced plastic or carbon composites. Combinations of these or similar materials may also be used to form the substrate 114.

In an embodiment, the flexible x-ray detector 104 further comprises a TFT array. The thin film transistor (TFT) array is typically a two-dimensional array of thin film transistors arranged in a particular order on a surface of the substrate 114. The thin film transistors of the TFT array may be arranged in a side by side manner or may be arranged with gaps in between the individual thin film transistors. By way of example, the TFT array may be provided as an array of passive or active pixels which store charge for read out by electronics. The TFT array is typically disposed on an active layer formed of amorphous silicon or an amorphous metal oxide, or organic semiconductors. Suitable amorphous metal oxides include zinc oxide, zinc tin oxide, indium oxides, indium zinc oxides (In—Zn—O series), indium gallium oxides, gallium zinc oxides, indium silicon zinc oxides, and indium gallium zinc oxides (IGZO). IGZO materials include InGaZnO₄ and InGaO₃(ZnO)ₘ, where m is <6. Suitable organic semiconductors include, but are not limited to, conjugated aromatic materials, such as rubrene, tetracene, pentacene, perylenediimides, tetracyanoquinodimethane and polymeric materials such as polythiophenes, polybenzodithiophenes, polyfluorene, polydiacetylene, poly(2,5-thiophenylene vinylene) and poly(p-phenylene vinylene) and derivatives thereof. Each pixel may include a patterned second electrode.

Photodiodes are typically fabricated over the imaging TFT array in layer form and may be formed as inorganic photodiodes or as organic photodiode (OPD) formed in a single layer or in multiple layers. The photodiode layer may be directly disposed on the TFT array or the design may include one or more layers disposed between the photodiode layer and the TFT array. In an embodiment, a plurality of photodiodes is arranged in the photodiode layer on the TFT array. In an embodiment, the TFT array is electrically connected to the photodiode layer. Each photodiode may include an anode, a cathode, and an organic film between the anode and the cathode, which produces charged carriers in response to absorption of light. The diode material may be lithographically patterned or un-patterned P-I-N a-Si or a solution coated organic photodiode or other suitable thin film photodiode material.

In other embodiments, flexible x-ray detector 104 may further include one or more of a field effector transistor (“FET”), scan electronics, readout electronics, a complex programmable logic device (“CPLC”), power-regulating electronics, a wireless card, or a combination thereof. Additional components may also be included in flexible x-ray detector 104 as described herein or known by those skilled in the art at this time or developed in the future. A person skilled in the art will appreciate that other components that may be made small and flexible may be included within the flexible x-ray detector 104.

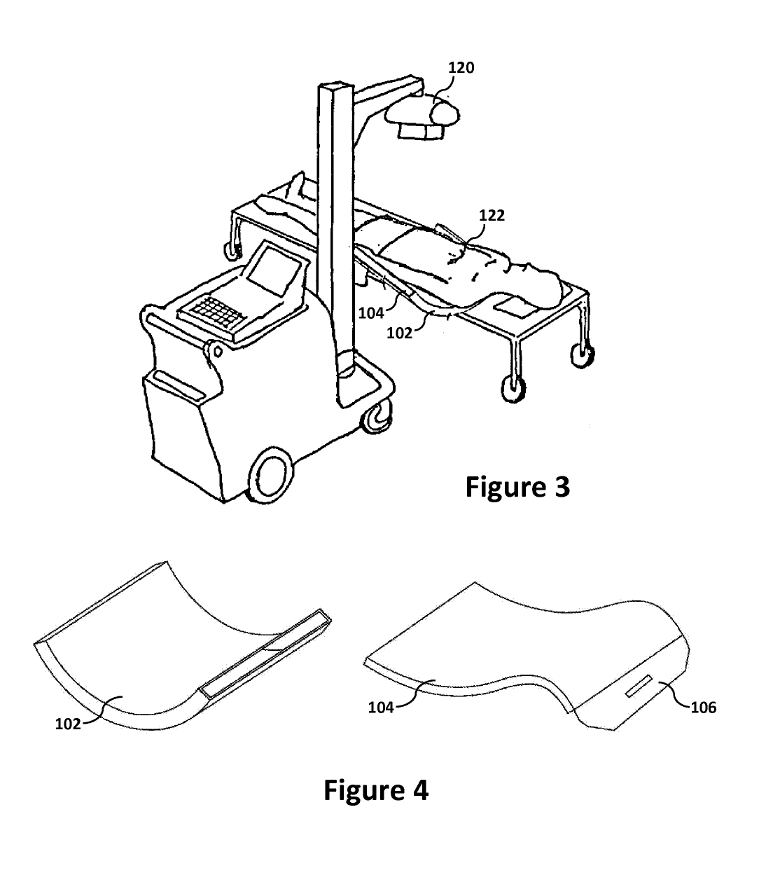

Referring to FIG. 3, an illustration is shown of an x-ray detector apparatus 100 in use with an x-ray source 120 as it may be used for x-ray imaging of a patient 122. The x-ray detector apparatus 100 is shown in the configuration illustrated in FIG. 1, where the flexible x-ray detector 104 is shown inserted into the curvature-fixing holder 102. The x-ray detector apparatus 100, comprised of the flexible x-ray detector 104 and curvature-fixing holder 102 may be placed behind the back and/or arms of a patient 122. Advantageously, the flexible x-ray detector 104 is inserted into the curvature-fixing holder 102 prior to the x-ray detector apparatus 100 being placed behind the patient or used in any manner for x-raying a patient; however, the flexible x-ray detector 104 may also be inserted into curvature-fixing holder 102 after placement in relation to the patient 122, or inserted partially prior to placement in relation to the patient 122.

The x-ray detector apparatus 100 may be used in conjunction with an x-ray source 120. In such a configuration, x-ray radiation originates at the x-ray source 120, passes through the patient 122, passes through the curvature-fixing holder 102, and contacts the detector 104. The x-rays received by the detector may then be transformed into an image that may be used for diagnostic or other purposes.

More specifically, visible light impinging on the photodiode layer (such as from the scintillator layer 112 discussed above) partially discharges capacitance of the diodes of the photodiode layer. The amount of photodiode discharge is proportional to the quantity of the incident light. Each pixel of the TFT array incorporates a switching field effect transistor (FET) used to control when charge is restored to the photodiode capacitance. The charge required to restore the capacitance may be provided and measured by external charge measurement circuitry. This circuitry, coupled with the TFT array, allows sequential scanning and readout of all photodiodes in the array. A custom A/D integrator/converter is normally used to measure the charge required to restore the photodiode to its initial un-discharged state. The magnitude of the discharge is proportional to the incident X-ray dose at each pixel integrated by both the scintillator layer 112 and the photodiode layer during the length of the X-ray exposure. The final X-ray image may then be reconstructed pixel-by-pixel using the photodiode layer discharge levels to set the image pixel intensity.

Although illustrated as being used with the patient 122 lying on a table, the apparatus disclosed herein may be utilized with a patient who is sitting, standing, or otherwise positioned. Additionally, although being shown as being used to image a patient's torso, the apparatus may be utilized to image a patient's other body parts, including but not limited to arms, legs, chest, back, skull, and fingers. The curvature-fixing holder 102 is shown in FIG. 3 to be a size sufficient to fit around the back of the patient 122. Curvature-fixing holder 102 may be of any size and curvature to adequately image a patient 122 or other volume based upon imaging facts and circumstances, including, for example, the size, flexibility, shape, and other characteristics of an object to be imaged.

The use of a curvature-fixing holder of known curvature provides undistorted images in a unique array of situations. By way of example, a curvature-fixing holder may be located within a leg brace and a flexible x-ray detector may be placed within the holder in the leg brace. In another embodiment, the curvature-fixing holder may be located within a neck brace of known curvature, allowing the flexible x-ray detector to be utilized in conjunction with the already present neck brace. A flexible display may be further included opposite from the flexible x-ray detector, allowing doctors to view the imaging results on the anatomy.

Referring to FIG. 4, the flexible x-ray detector 104 is shown outside of curvature-fixing holder 102, or in a position apart from curvature-fixing holder 102, such as prior to or after an x-ray procedure has been performed. In an embodiment, the flexible x-ray detector 104 includes a handle 106. The handle 106 may be firm and may be composed of engineering plastics such as polycarbonate, PBT, ABS, or a combination thereof. Those skilled in the art will appreciate that other engineering plastics may be used as a material for handle 106. In an embodiment, a handle is located on at least one of the flexible x-ray detector and the curvature-fixing holder.

In an embodiment of the flexible x-ray detector 104 having a handle 106, lightweight metals and alloys, such as aluminum and magnesium alloys can be used to form the handle 106. Additionally, materials with thermal conductivity for heat dissipation of electronics may be used for the handle 106. In an embodiment, the handle comprises carbon fiber reinforced polymers. The handle 106 may be firm and include a motherboard, a battery, a power supply, a regulator, wireless communication components, fiber optic communication components, or a combination thereof. In an embodiment, the handle 106 is coupled to the flexible x-ray detector 104, as shown in FIG. 4. The handle 106 may also or separately coupled to the curvature-fixing holder 102. Alternatively, both the flexible x-ray detector 104 and the curvature-fixing holder 102 may have a handle 106. In an embodiment, handle 106 is removable from a flexible x-ray detector 104 and/or a curvature-fixing holder 102. The handle 106 may be in wired or wireless communication with the flexible x-ray detector 104. In an embodiment, the flexible x-ray detector 104 is removed from the curvature-fixing holder 102 via the handle 106.

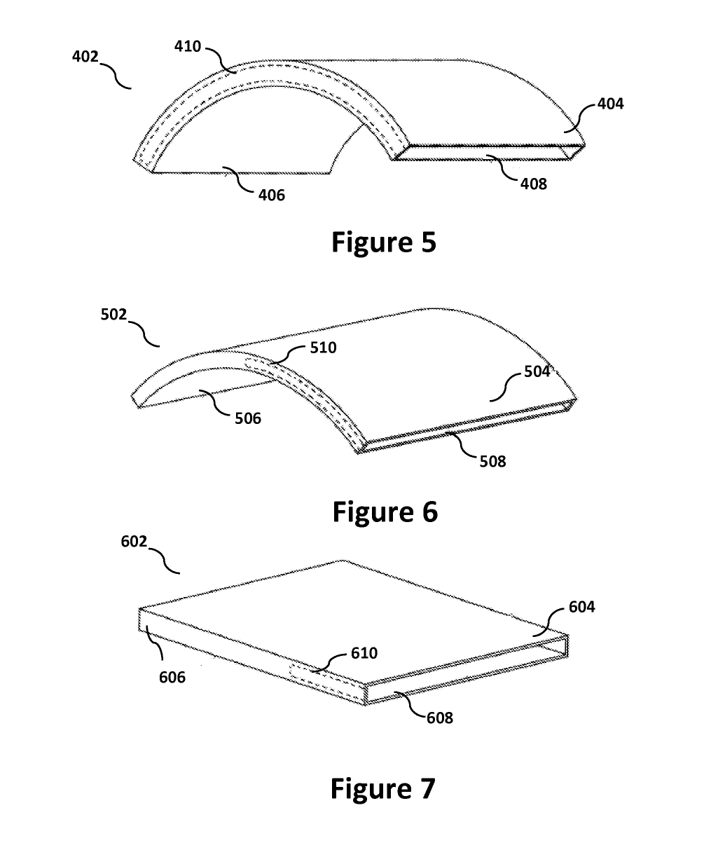

Several embodiments of the curvature-fixing holder 102 are shown in FIGS. 5-10, where like features are denoted by similar reference numbers increased by “100” (for example, convex-curved holders 402, 502, and 602). FIGS. 5-7 illustrate various embodiments of convex-curved holders. Referring to FIG. 5, the convex-curved holder 402 has a perimeter defining an internal recess 408, a first end 404 and a second end 406. Referring to FIG. 6, the convex-curved holder 502 has a perimeter defining an internal recess 508, a first end 504 and a second end 506. Referring to FIG. 7, the convex-curved holder 602 has a perimeter defining an internal recess 608, a first end 604 and a second end 606.

In comparing the embodiments of convex-curved holders 402, 502, and 602, differences in the holders and uses for the holders will be appreciated by those skilled in the art. For example, the convex-curved holder 402 is thicker, meaning the convex-curved holder has a greater width than the convex-curved holder 502. A larger flexible x-ray detector or an x-ray detector having a greater width may be used in the convex-curved holder 402 than in 502. Alternatively, a smaller x-ray detector may be used in both the convex-curved holder 502 and 402. A user may prefer to use a smaller x-ray detector in convex-curved holder 502, because the smaller x-ray detector would fit in a more snug fashion and be better held in place in embodiments of convex-curved holder 502 than in convex-curved holder 402.

Though not the only uses, a user of an x-ray apparatus may prefer to use a convex-curved holder 402 for larger objects or heavier objects, such as a patient's back or on an adult. Alternatively, a user of an x-ray apparatus may prefer to use the convex-curved holder 502 for smaller or lighter objects, such as a patient's arm or for a child. The convex-curved holder 602 may also be substantially uncurved as shown in FIG. 7. This type of holder may be rigid and substantially uncurved, or flexible and take on a curved shape through manipulation by a user, after insertion of a flexible x-ray detector, or through conforming the convex-curved holder 602 to a patient or an object.

The dashed lines 410 of FIG. 5, 510 of FIG. 6, and 610 of FIG. 7 illustrate the positioning of a flexible x-ray detector similar to flexible x-ray detector 104 discussed above within convex-curved holders 402, 502, and 602 respectively. Dashed lines 410, for example, illustrate the positioning of a flexible x-ray detector within convex-curved holder 402, where the flexible x-ray detector extends substantially from first the first end 404 to the second end 406. Dashed lines 510 illustrate the positioning of a flexible x-ray detector within convex-curved holder 502, where the flexible x-ray detector extends approximately half way between the first end 504 to the second end 506. Dashed lines 610, illustrate the positioning of a flexible x-ray detector within convex-curved holder 602, where the flexible x-ray detector extends approximately half way between the first end 604 to the second end 606.

In an embodiment, a flexible x-ray detector may be inserted to any position, such as 410, 510, or 610, or a position between any of these, where an internal recess extends substantially from a first end to a second end of a holder. In other words, although a recess may extend from the first end to a second end of a holder, the flexible x-ray detector may be inserted partially, fully, or at a position in-between. In another embodiment, the internal recess, such as recesses 408, 508, and 608 limit the depth a flexible x-ray detector may be inserted. For example, the recess 508 may not extend substantially from first end 504 to second end 506, but extend approximately half way there between. In an embodiment such as this, a flexible x-ray detector may only be inserted as far as recess 508 extends and would stop approximately halfway between the first end 504 and the second end 506.

This embodiment may have uses, such as when the entire flexible x-ray detector is not needed or a smaller flexible x-ray detector is utilized. This embodiment could be used where a patient is laying on a table, such as in FIG. 3, and only the patient's arm requires an x-ray. The portion of convex-curved holder 502 that does not hold a flexible x-ray holder may be inserted under a patient to hold the portion of the convex-curved holder 502 in place surround a patient's arm. In this embodiment, a flexible x-ray detector would be located close to an area to be x-rayed, but not under portions of a patient that are not being x-rayed.

In another embodiment, at least part of the flexible x-ray detector is not covered by the curvature-fixing holder (whether convex or concave), where at least part of the detector is exposed from the holder, which allows a user to x-ray portions of a patient having different curvature and lines. For example, an embodiment of the x-ray detector apparatus may be used on a flat hand with curved fingers or a lower leg with a pointed foot where the anatomy is flat in the ankle region but curves along the top of the foot. In an embodiment, an additional flat attachment could be added and/or attached to the curvature-fixing holder, such that the flat attachment covers at least a portion of the detector that is not covered by the holder. In another embodiment, substantially all of the detector is covered by the holder.

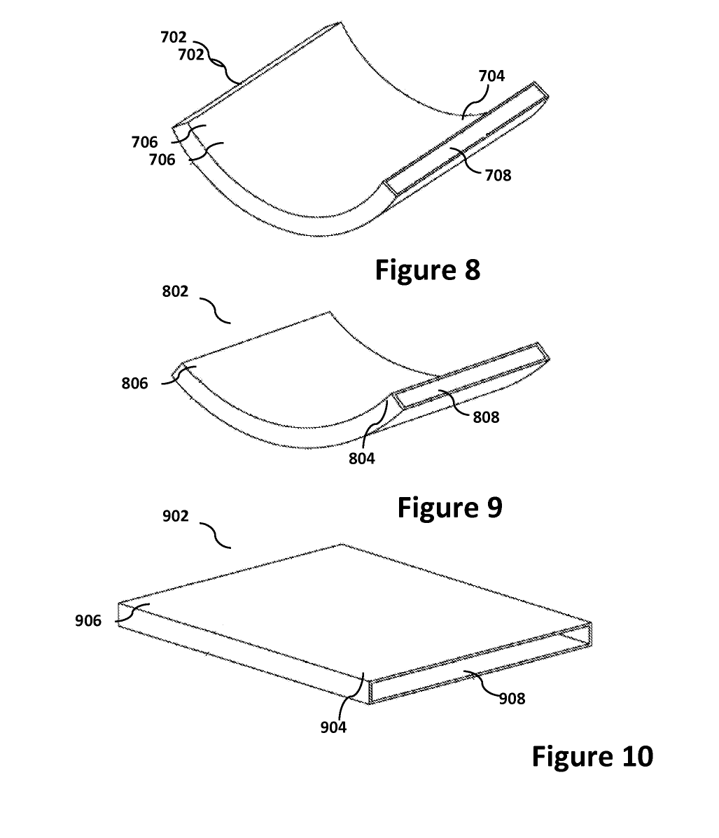

FIG. 8, FIG. 9, and FIG. 10 illustrate concave-curved holders 702, 802, and 902 in accordance with concave embodiments of the x-ray detector apparatus. Each concave-curved holder has a first end 704, 804, 904, a second end 706, 806, 906. Each concave-curved holder has a perimeter, which defines a recess 708, 808, 908, respectively configured to receive a flexible x-ray detector, such as flexible x-ray detector 104.

It should be understood that the positioning of a flexible x-ray detector or the depth of a recess as shown in FIGS. 5-7 may also be used on any of FIGS. 5-10. For example, the concave-curved holder 808 may have an interior recess, which positions a flexible x-ray detector in a similar fashion to that illustrated in either FIG. 5 or FIG. 7.

In an embodiment, where a convex-curved holder and a flexible x-ray detector (e.g. convex-curved holder 402 of FIG. 5), the convex-curved holder may be flipped to yield a holder with a concave curvature (e.g. concave-curved holder 702 of FIG. 8). For the purpose of this paragraph, “flipped” refers to manipulation of the element to an opposite position, such as a 180 degree rotation along a particular axis. In such an embodiment, the flexible detector may be removed, flipped, and re-inserted into the flipped holder. In an embodiment, the flexible detector and/or holder include(s) mating or complimenting component(s) to assist with this arrangement. Likewise, where a holder and detector are configured in a concave curvature, a similar configuration is possible. That is, a concave-curved holder (e.g. holder 802 of FIG. 9) may be flipped, the flexible detector may be removed, flipped, and re-inserted to achieve a holder of convex curvature (e.g. convex-curved holder 502 of FIG. 6) with a properly oriented flexible detector.

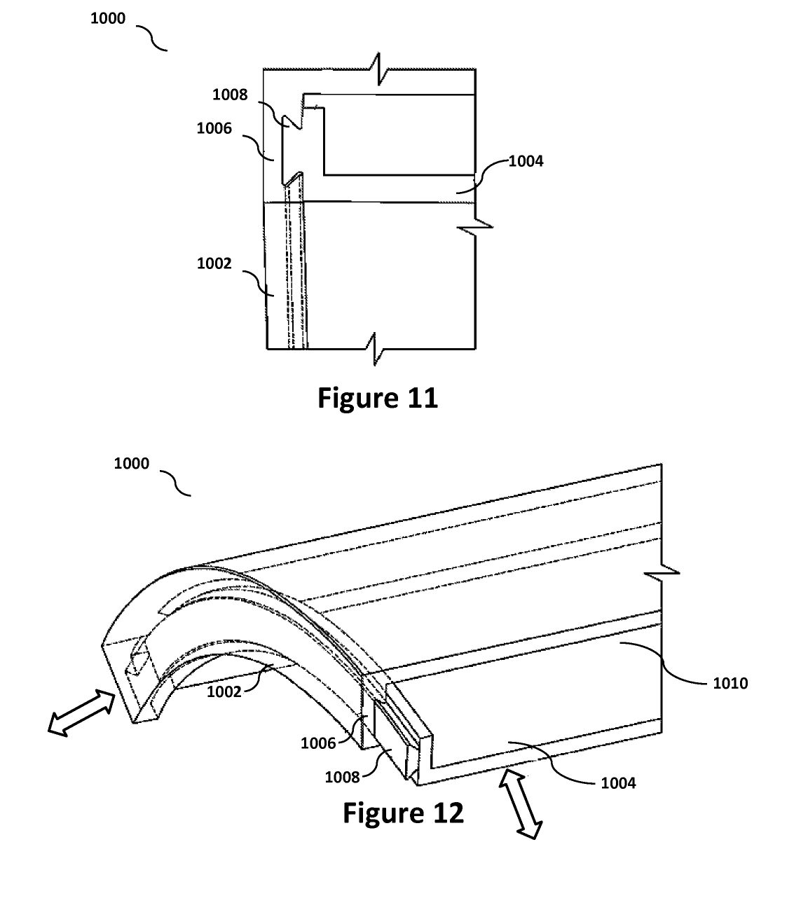

Referring to FIG. 11 and FIG. 12, a curvature fixing holder is shown, which includes features that assist in the guidance or coupling of a holder and a detector. More specifically, these features aid in the insertion of a detector into a holder and/or to assist in securing and/or stabilizing the detector within the holder. In an embodiment, a holder 1000 is comprised of at least two parts, a curvature fixing holder 1002 and an insert 1004. The insert 1004 may comprise a part of the perimeter of curvature-fixing holder 1002, such as the bottom part, or may be inserted adjacent to the perimeter of curvature-fixing holder 1002, for example, where the insert 1004 is inserted above an already existing bottom part.

A track 1006 is shown on curvature-fixing holder 1002 and a protrusion 1008 is shown on the insert 1004, which creates a track and protrusion mating between an insert 1004 and the curvature-fixing holder 1002. Complimenting components guide the insert 1004 along the curvature of a recess 1010. A flexible x-ray detector (not shown) may also be inserted into recess 1010. The use of complimenting components enables the curvature to be applied to a configurable section of the detector. The track and protrusion mating between the insert 1004 and the curvature-fixing holder 1002 allows for adjustment of the arc length of the curvature-fixing holder 1002. In an alternative embodiment, the track may be present on the insert 1004 and the protrusion may be present on the curvature-fixing holder 1002.

A user may wish to adjust the arc length when acquiring images of different portions of a patient's body to best fit the portion being imaged, which may result in better image quality. For example, a wider arc length may be more appropriate for use when imaging a patient's back, whereas a smaller arc length may be used when imaging a patient's ankle. Similarly, a wider arc length may be more appropriate for an adult patient, whereas a smaller arc length may be more appropriate for a child.

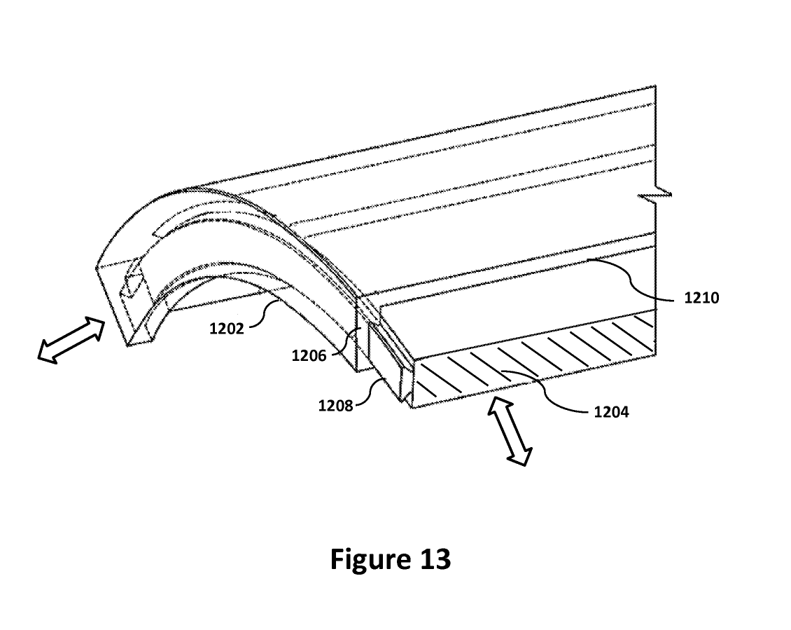

Referring to FIG. 13, a holder and flexible x-ray detector is shown. In this embodiment, a track 1206 is shown on holder 1202 and a protrusion 1208 is shown on flexible detector 1204, which creates a track and protrusion mating between a flexible x-ray detector, such as flexible x-ray detector 104 of FIGS. 1-4 and a curvature-fixing holder, such as curvature-fixing holder 102 of FIGS. 1-4. Complimenting components guide the flexible x-ray detector along the curvature of the recess 1210. The use of complimenting components enables the curvature to be applied to a configurable section of the flexible x-ray detector through interaction between the curvature-fixing holder and the flexible x-ray detector. In an alternative embodiment, the track may be present on the flexible detector and the protrusion may be present on the holder. In other embodiments to the exemplary embodiments shown in FIGS. 11-12, other mating mechanisms may be utilized, such as a dove-tail mechanism, a T-slot or an L lap-joint.

In yet another embodiment (not shown), a curvature-fixing holder may be adjustable to fit flexible x-ray detectors having a different size and/or shape and/or where a portion of a flexible x-ray detector extends beyond the curvature-fixing holder. The size and shape of the x-ray detectors may vary based on the length, width, thickness, height, arc length, curve, perimeter, flexibility, pliability, and/or geometric aspect of the x-ray detector. For example, a curvature-fixing holder could be adjusted or extended to fit a larger flexible x-ray detector or may be adjusted or retracted to fit a smaller flexible x-ray detector. In another embodiment, the curvature-fixing holder may be adjustable to accommodate the size and shape of the flexible x-ray detector, so as to cover the entire flexible x-ray detector or any portion thereof. For example, the curvature-fixing holder may be adjusted so that a portion of a flexible x-ray detector extends beyond the curvature-fixing holder, such as for use where the curvature-fixing holder would be applied to a patient's leg, and the flexible x-ray detector extends beyond the holder is applied to a patient's foot.

In one embodiment, the adjustable curvature-fixing holder has adjusting means. In another embodiment, the adjustable curvature-fixing holder may be formed of two or more parts, where one part slides under another part to either extend or lessen the length or size of the curvature-fixing holder. The adjustment of the curvature-fixing holder may be performed by a user or machine moving two or more parts with respect to another part. For example, an adjustable curvature-fixing holder in its fully extended state may be adjusted to fit or accommodate a flexible x-ray detector of a smaller size. In this case, a first part of the curvature-fixing holder may slide under a second part of the curvature-fixing holder to make the curvature-fixing holder smaller. Any complimentary components may be used to adjust the curvature-fixing holder, such as a mating mechanism, dove-tail mechanism, and/or a T-slot or an L lap-joint.

In another embodiment, an x-ray detector system includes an adjustable curvature-fixing holder, which has a first end, second end, and a defining recess. The system further includes a plurality of flexible x-ray detectors, where at least two flexible x-ray detectors have a size differing from one another. In an embodiment, each of the plurality of flexible x-ray detectors has a different size relative to one another. Each flexible x-ray detector includes a scintillator and/or a flexible substrate. The adjustable curvature-fixing holder is configured to be adjusted to accommodate the size of each of the plurality of flexible x-ray detectors. In an exemplary embodiment, the x-ray detector system would allow for one or more curvature-fixing holders to accommodate the size of a plurality of flexible x-ray detectors, wherein the curvature-fixing holder is adjustable to accommodate the size and shape of each of the plurality of flexible x-ray detectors, so as to cover each flexible x-ray detector completely or any portion thereof.

In an embodiment, the complimenting components may be configured such that a flexible x-ray detector and a curvature-fixing holder cannot be improperly oriented, which aids in reliable image acquisition. In such an arrangement, only one orientation is possible. In another embodiment, the complimenting components may be configured such that only one concave and one convex orientation of the flexible and detector may be possible. In yet another embodiment, the holder and detector may include a locking mechanism that may be engaged to secure the flexible x-ray detector within the curvature-fixing holder until a user requires removal of the flexible x-ray detector from the curvature-fixing holder. Once inserted, a detector may be held in place relative to the holder by friction, by a fixing device, or structure, such as a latch, fastener or any other mechanical or electro-mechanical fastener currently known or that later becomes known, to form an x-ray detector.

An x-ray detector system may include a plurality of curvature-fixing holders, each having a different, predetermined and known curvature. In an embodiment of the x-ray detector system, the system includes a plurality of curvature-fixing holders each having a different, predetermined curvature, and a plurality of flexible x-ray detectors, wherein each detector of the plurality is configured to be inserted into the recess of at least one of the plurality of curvature-fixing holders.

By way of example, in one embodiment of a system, the system may include five curvature-fixing holders (e.g. 402, 502, 602, 702, and 802). In this system, each curvature-fixing holder may have a different shape and curvature when compared to other curvature-fixing holders within the system.

In another embodiment of the system, one or more of five holders may be chosen based on the desired use and/or object to be imaged. For example, a curvature-fixing holder having a small radius (e.g. 402) may be utilized to image a hand. Similarly, a curvature-fixing holder having a larger radius (e.g. 502) may be utilized to image a knee, and an even larger radius (e.g. 602) may be used to image a back. In an embodiment, the system includes a flexible x-ray detector as described above. In some embodiments, a single flexible x-ray detector can be used in all curvature-fixing holders though the curvature-fixing holders vary in shape or size. In other embodiments, multiple flexible x-ray detectors may be used, which correspond to the particular size, shape, and/or purpose of the curvature-fixing holders within the system.

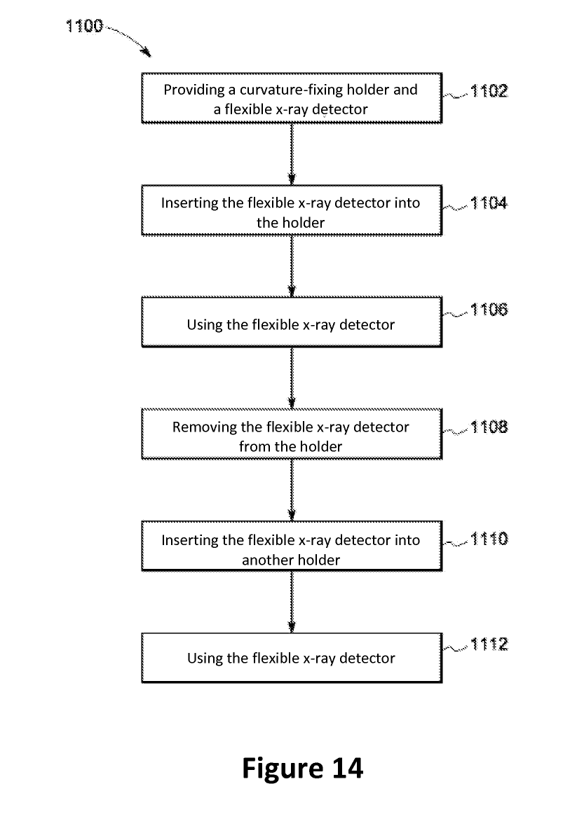

Referring to FIG. 14, a flowchart of an exemplary method 1100 of using an x-ray detector apparatus 100 comprising a curvature-fixing holder and a flexible x-ray detector is illustrated. At step 1102, a curvature-fixing holder and flexible x-ray detector are provided. The curvature-fixing holder and flexible x-ray detector may be provided simultaneously or at different times. At step 1104, the flexible x-ray detector is inserted into the curvature-fixing holder. Optionally, the flexible x-ray detector is locked or further secured into place within a recess of the curvature-fixing holder once the flexible x-ray detector is inserted to a desired depth or is inserted fully into the recess of the curvature-fixing holder.

Once the flexible x-ray detector has been inserted into the curvature-fixing holder forming an x-ray detector apparatus, a user or machine may optionally position the x-ray detector apparatus around, next to, or upon a volume to be x-rayed, for example, the arm of a patient.

At step 1106, a user of an x-ray system uses the flexible x-ray detector within the x-ray detector apparatus to acquire one or more x-ray images. Upon the acquisition of one or more x-rays, a user or machine may optionally remove or displace the x-ray detector apparatus from a patient or object being x-rayed.

At step 1108, the flexible x-ray detector may be removed from the curvature-fixing holder for storage, during imaging processing, or for preparation of the next object to be x-rayed. In an embodiment, at step 1110 the flexible x-ray detector may be inserted into another curvature-fixing holder, where a user of an x-ray system uses the flexible x-ray detector within the x-ray detector apparatus to acquire one or more x-ray images at step 1112.

The method described above may include some or all of the illustrated steps of the method 1100, and may include additional steps not illustrated by FIG. 14. For example, an embodiment of a method of using the x-ray detector apparatus may include providing the apparatus and/or system at step 1102, inserting the detector into the holder at step 1104, and using the detector at step 1106 only. A different embodiment of the method may include steps 1102-1106 and further include removing the detector from the holder at step 1108, placing the detector into a different holder at step 1110, and using the detector at step 1112.

By using the apparatus disclosed, an advantageous flexible detector may be utilized, the flexible detector having a known curvature, which allows for image distortion to be removed. As a result, users may utilize flexible detectors in various circumstances without sacrificing or deteriorating image quality. The present disclosure provides an apparatus, system, and method that enable the determination of detector curvature to permit image distortion correction.

As used herein, an element or step recited in the singular and preceded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. An curved x-ray detector apparatus comprising:
a curvature-fixing holder of predetermined curvature, the holder having a first end and a second end and defining a recess that has substantially the same predetermined curvature as the holder; and
a flexible x-ray detector comprising:
a scintillator; and
a flexible substrate,
wherein the flexible detector is configured to be inserted into the recess and follow the predetermined curvature of the recess.

2. The apparatus of claim 1, wherein the flexible detector is removable from the curvature-fixing holder.

3. The apparatus of claim 1, wherein the curvature-fixing holder has a fixed curvature.

4. The apparatus of claim 1, wherein the apparatus comprises readout electronics within at least one of the curvature-fixing holder and the flexible x-ray detector.

5. The apparatus of claim 1, wherein the flexible x-ray detector further comprises a TFT array and readout electronics

6. The apparatus of claim 1, wherein the flexible x-ray detector is at least partially exposed from the curvature-fixing holder.

7. The apparatus of claim 6, further comprising an attachment covering at least a portion of the exposed flexible x-ray detector.

8. The apparatus of claim 1, further comprising a handle, wherein the handle is located on at least one of the flexible x-ray detector and the curvature-fixing holder.

9. The apparatus of claim 1, wherein the holder and flexible x-ray detector have complimenting components to guide the flexible x-ray detector along the curvature of the recess.

10. The apparatus of claim 9, wherein one of the curvature-fixing holder and the flexible x-ray detector comprises a track and the other of the curvature fixing holder and the flexible x-ray detector comprises a protrusion that complements with the track.

11. The apparatus of claim 1, wherein the holder is an adjustable holder configured to cover any portion of the detector.

12. The apparatus of claim 9, wherein the complimenting components are configured such that the detector and holder cannot be improperly oriented.

13. The apparatus of claim 9, wherein the complimenting components are configured such that only one concave orientation and one convex orientation of the detector and holder are possible.

14. An x-ray detector system comprising:
a plurality of curvature-fixing holders, each of a different, predetermined curvature, each holder having a first end and a second end, each holder defining a recess that has substantially the same predetermined curvature as the respective holder; and
a flexible x-ray detector comprising:
a scintillator; and
a flexible substrate,
wherein the flexible detector is configured to be inserted into each recess and follow the predetermined curvature of each of the plurality of curvature-fixing holders.

15. The x-ray detector system of claim 14, further comprising a plurality of flexible x-ray detectors, wherein each detector of the plurality is configured to be inserted into the recess of at least one of the plurality of curvature-fixing holders.

16. A method of using the apparatus of claim 1, the method comprising:
providing the apparatus of claim 1;
inserting the flexible x-ray detector into the holder; and
using the x-ray detector.

17. A method of using the system of claim 14, the method comprising:
providing the system of claim 14;
inserting the flexible x-ray detector into a first holder of the plurality of curvature-fixing holders;
using the x-ray detector in the first holder;
removing the flexible detector from the first holder;
inserting the flexible x-ray detector into a second holder of the plurality of curvature-fixing holders; and
using the x-ray detector in the second holder.

18. The apparatus of claim 1, wherein the curvature-fixing holder is adjustable to accommodate the size and shape of the flexible x-ray detector, so as to cover the entire flexible x-ray detector or any portion thereof.

19. The apparatus of claim 18, further comprising a plurality of flexible x-ray detectors, wherein the curvature-fixing holder is adjustable to accommodate the size and shape of each of the plurality of flexible x-ray detectors, so as to cover each flexible x-ray detector completely or any portion thereof.
